(19) United States
(12) Patent Application Publication
(10) Pub. No.: US 2026/0165283 A1
(43) Pub. Date: Jun. 18, 2026

(54) LIVESTOCK ANIMAL MANAGEMENT SYSTEM

(71) Applicant: LELY PATENT N.V., Maassluis (NL)

(72) Inventors: Karel VAN DEN BERG, Bleskensgraaf (NL); Korstiaan Cornelis BLOKLAND, Goudriaan (NL); Paulus Jacobus Maria VAN ADRICHEM, Delfgauw (NL); Martinus Cornelis Johannes BUIJS, Heerle (NL)

(73) Assignee: LELY PATENT N.V., Maassluis (NL)

(21) Appl. No.: 19/129,484

(22) PCT Filed: Nov. 23, 2023
(86) PCT No.: PCT/IB2023/061837

§ 371 Date: May 13, 2025

(30) Foreign Application Priority Data
Nov. 24, 2022 (NL) 2033606

(51) Int. Cl. A01K 1/00; A01K 1/02; A01K 1/10; A01K 5/01; A01K 5/02; A01K 29/00

(52) U.S. Cl. CPC A01K 1/0023; A01K 1/0209; A01K 1/105; A01K 5/01; A01K 5/0225; A01K 5/0275; A01K 5/0291; A01K 29/005

(57) ABSTRACT

A livestock animal management system includes a livestock shed with a livestock space for livestock animals, a feed fence provided in the livestock shed with a plurality of feed fence positions where the livestock animals are able to eat animal feed through the feed fence, a livestock animal locating system for determining and monitoring positions of the livestock animals in the livestock shed, and a control device which is connected to the livestock animal locating system for receiving and processing the positions. The control device is configured for generating an animal alarm if the position of a livestock animal remains within a distance threshold of one of the feed fence positions for at least a time threshold.

The present invention relates to a livestock animal management system, comprising a livestock shed with a livestock space for livestock animals, a livestock animal locating system which is configured for determining and monitoring positions of the livestock animals in the livestock shed, and a control device which is connected to the livestock animal locating system and is configured for receiving and processing said positions.

Such systems are known per se. Thus, EP3336783-A discloses a system for tracking livestock animals in a shed which generates an alarm when an animal has not moved for at least a certain amount of time.

This system has a few limitations. Thus, there are areas where a state of non-movement occurs often, such as cubicles. In addition, in many areas in the livestock space, it is not relevant if an animal does not move. This may generate many undesirable alarms. In addition, there may be cases where a livestock animal still moves, but where there is still cause to generate an alarm, for example in case of entrapment.

It is therefore an object of the present invention to improve a livestock animal management system of the specified kind in such a way, that it becomes more reliable with regard to generating an alarm, at least in particular situations.

This object is achieved by the invention by means of a livestock animal management system according to Claim 1.

The inventors have realised that in particular the feed fence, and the fact that livestock animals have to stick their head through the latter in order to reach the feed, may give rise to undesirable situations. There may be, for example, cases where an animal becomes trapped, e.g. due to slipping and falling or even by being pushed over by another livestock animal. In those cases, it is obviously desirable to be able to generate an alarm. There may also be cases where an animal which has become trapped in the feed fence due to such a fall or the like does still move, e.g. flounders. Due to the invention not primarily focusing on movement, but more on a position within a distance threshold from a feed fence position, cases in which, incorrectly, no alarm is generated are prevented. Thus, the reliability of raising an alarm is improved, at least for situations in relation to a feed fence.

It should be noted here that in order to generate the alarm, it is not important to know which animal seems to be stuck at a feed fence position. The system according to the invention does therefore not have to be able to identify the livestock animals at an individual level (animal-ID), even if that may be an advantage for particular embodiments. In addition, the distance threshold may be selected on the basis of the (average) animal size, the type of animal locating system and the like, so that it is possible to distinguish clearly between animals which have actually stuck their heads through the feed fence, and animals which are only walking past. In this case, empirical tests may produce useful data. It should also be noted that the animal, which is virtually always provided with a collar with animal-ID or the like, may also become stuck due to the collar becoming caught. After all, it is the head and the neck, including the collar, which are stuck through the fence. This may result in the animal being able to partly pull back. For example, it may be the case that the animal has completely freed itself from the feed fence, but that the collar is still caught, so that the animal cannot go anywhere. Preferably, the distance threshold should also take this into account.

Particular embodiments are described in the dependent claims and in the following part of the description.

In embodiments, the feed fence positions are individually and/or integrally lockable. In practice, feed fences are often used to secure an individual livestock animal, or also a plurality of or all animals which are at the feed fence. To this end, for example, feed fences are known such as described in WO2012062377A1. On occasion, it may occur that someone forgets to unlock the feed fence, for example when the operator is suddenly called away. The respective one or more animals will then obviously remain standing in their spot for a long time. By generating the alarm in a targeted manner, it is possible to efficiently prevent further harm by unlocking the feed fence in situ or remotely.

In particular, the time threshold depends on the time since the most recent feed provision event. More particularly, the shorter the time since the most recent feed provision action, the longer the time threshold is. This takes into account the fact that when feed becomes available, the dwell time of livestock animals at the feed fence will on average be longer, so that the time threshold is likewise advantageously longer. In this case, the time threshold may be, for example, a step function which, after a predetermined period, changes from a longer time threshold to a shorter time threshold. It is also possible for the time threshold T to decrease gradually after the time t which has lapsed since the feed provision action, such as T(t)=T₀*(1.5−t) for 0<t<0.5, and T=T₀ for t≥0.5, with t in hours. Obviously, virtually any other mathematical function is also possible, and empirical values for time thresholds and their variation can easily be selected in practice.

For example, the cattle breeder may input the times of the feed provision action(s) into the control device himself. In embodiments, the livestock animal management system comprises an automatic feeding system for dispensing feed at the feed fence, wherein the feeding system is configured to transmit the time of a feed provision event to said control device. An example of such a feeding system is the Lely Vector®. In this way, the occasions when feed is provided are automatically kept track of, so that errors can be prevented.

In embodiments, the feed provision event comprises providing fresh feed at the feed fence or pushing back previously dispensed feed. By way of example, it should be noted that that, for example, the Lely Vector® system is able both to provide fresh feed and to push back previously dispensed feed which has been scattered by the livestock animals in such a way that it was out of range. Strictly speaking, the latter does not constitute providing fresh feed, but as it does make feed available again to the livestock animals, it is regarded as a feed provision action. To this end, for example, a Lely Juno® or another feed pusher may be provided which moves along the feed fence and pushes back feed.

The livestock animal locating system is not particularly limited and may, for example, comprise a series of receivers, with each animal being provided with an optionally unique transmitter. However, advantageously the livestock animal locating system comprises a camera system having at least one camera for repeatedly recording images of at least a part of the livestock shed including the feed fence, and an image-processing device for processing the images and identifying one or more animals in said images. Since feed fences are virtually always made of metal, the transmission of animal data by a transmitter, which is usually arranged around the neck, or possibly on the ear, of the livestock animal, may not always be reliable. In the case of a camera system as in this embodiment, interference by metal parts is not an issue and, in addition, it is advantageous that most livestock animals, in particular cattle, but optionally also horses and the like, are large. The accuracy required in, on the one hand, identifying a livestock animal and, on the other hand, determining the position is therefore not excessive. Usually, one or a few cameras are sufficient to monitor the one or more feed fences which have been provided in the livestock space. It should be noted here that it is not necessary to identify the livestock animals down to an individual level, as long as it is ensured that an individual livestock animal, even of unknown identity, can be tracked without the risk of being mistaken for another livestock animal. In practice, the size of most livestock animals renders this easily possible. In case of (too) little ambient light, the livestock animal locating system may advantageously comprise one or more lamps for lighting the livestock space.

In embodiments, the image-processing device is furthermore configured for identifying a deviation from an upright position of the livestock animal in the image. Many livestock animals, in particular cattle, but also horses, buffalos and the like, have a relatively large length/width ratio as well as height/width ratio. If the livestock animal is no longer upright, there is therefore generally a significant change in this ratio which can be recognised relatively easily by the image-processing device. In addition, it is often also possible to identify, for example, laterally protruding legs or an entirely different, unexpected outline (from above, from the side, etc.). All such situations are an indication that the livestock animal has fallen down. For more details regarding the identification of the position and posture of animals, reference is made to Netherlands application no. NL-2031623 which was not published before the priority date of the present application, at least for a livestock animal locating system based on cameras.

If the non-upright position at the feed fence lasts excessively long, then this is an indication that an undesirable situation has arisen, such as, in particular, an injury. Such a situation can occur relatively frequently at a feed fence, because the freedom of movement of the animals is temporarily limited there, so that they are more prone to accidents, pushing by other animals, etc. In embodiments, the control device is therefore advantageously configured for generating a fall alarm if said deviation is present for at least a fall threshold. The system according to the invention helps to identify this at an early stage, so that assistance may be offered. It should be noted that a non-upright position in other situations, such as in a cubicle, does not have to be a problem at all. The fall threshold is an example of the time threshold according to the invention. In this case, the fall threshold will be relatively short, because this is usually a situation in which quick action is of the essence, should it be required. The fall threshold is, for example, 10 seconds. If the animal is still not in a non-upright position after 10 seconds, it may already be necessary to generate the alarm in order to take action. Obviously, the fall threshold can be adjusted as desired, but it will be clear that the fall threshold will be much shorter than, for example, a time threshold for animals being secured to the feed fence.

As has been described above, a prolonged stay of a livestock animal at a feed fence position does not necessarily have to be the result of a fall or an unfortunate case of entrapment. It is also possible that one or more animals have been secured to the feed fence, for example for the sake of an examination or treatment, such as trimming of hoofs or a veterinary treatment. It does happen that the operator forgets to release the animals, resulting in the one or more respective livestock animals not being able to leave the feed fence. In order to solve this situation by means of the livestock animal management system according to the invention, in embodiments, the control device is configured for emitting a lock alarm if the positions of a plurality of the livestock animals, in particular of all livestock animals along said feed fence, remain at least within the distance threshold of a respective one of the feed fence positions for at least the predetermined time threshold. In this case, the control device should advantageously only take into account livestock animals whose distance to a feed fence position is so small that it can be assumed that the livestock animal has pushed his or her head through the feed fence. More particularly, the image-processing device, or the control device which may in principle also comprise the image-processing device, is configured to identify if a livestock animal has stuck its head through the feed fence, so that the control device may (start to) monitor this animal. Other animals which only come to observe, but not to feed may thus be ignored. Animals which push their head through the feed fence at various feed fence positions in short succession in order to “cadge” feed may also be ignored, since they do indeed spend a long amount of time in total at/through the feed fence, but are by no means stuck. Advantageously, the image recognition device is configured for identifying livestock animals in the image which have pushed their heads through the feed fence. For example, by means of a system using one or more cameras, it is relatively simple to identify such livestock animals from above, since a part of the animal is perceived to be on the other side of the feed fence. If desired, this may however also be detected by means of, for example, a locating system using a transmitter which is worn by the livestock animal, since the transmitter is located on the other side of the feed fence. In each case, the “other side” refers to the side where the feed is deposited and where the livestock animals are prevented from going.

In embodiments, the livestock animal management system according to the invention furthermore comprises at least one autonomously navigating vehicle in the livestock shed, in particular in the livestock space, wherein the control device is furthermore configured to instruct said vehicle, when an animal alarm, fall alarm or lock alarm is generated, to maintain at least a predetermined distance to the respective feed fence position. Such autonomously navigating vehicles are, for example, manure slides, such as the Lely Discovery® or, in the feeding alley on the other side of the feed fence, a feed pusher, such as the Lely Juno®. When the control device determines that one or more livestock animals are probably stuck in the feed fence, it does not make sense for a vehicle to travel to or along that feed fence. This would only result in unnecessary stress for the animals, which are already unhappy, and in delay to the vehicle. By ordering the vehicle to maintain a minimum distance to the respective feed fence position(s), unnecessary collisions may be prevented. In practice, this may also mean that the control device commands the vehicle to choose another route, such as towards another feed fence without any stuck animals.

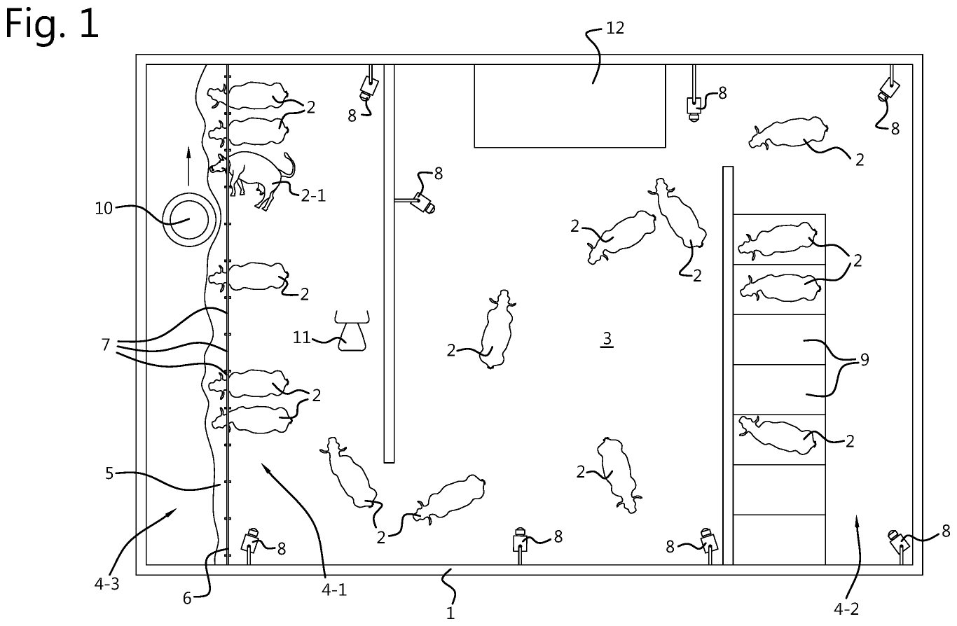

The invention will now be explained in more detail with reference to the drawing which shows an exemplary embodiment of the invention in the sole FIG. 1 in non-limiting form and in a diagrammatic top view.

FIG. 1 shows a diagrammatic top view of a livestock animal management system according to the invention. The system comprises a livestock shed 1, in which livestock animals 2 walk around in a livestock space 3, wherein 2-1 represents an animal which has fallen over. The livestock space 3 comprises a first alley 4-1, a second alley 4-2 and a third alley 4-3. Animal feed is provided behind a feed fence 6 with feed fence positions 7, and in addition cubicles 9 are provided.

Reference numeral 8 denotes a number of cameras for monitoring the livestock space. Reference numeral 10 denotes a feed pusher-AGV, and reference numeral 11 denotes a manure slide-AGV which are operatively connected to a control device 12.

The livestock shed 1 shown here is, for example, a milking parlour, in which incidentally no milking robot or the like is shown since this is not relevant to the invention. Here, the livestock animals 2, 2-1 are therefore dairy cows, although they could also be beef cattle, goats and the like, that is animals which can eat roughage/feed by means of a feed fence 6.

The roughage 5 is provided in the third alley 4-3 or the feeding alley. In the latter, a feed pusher 10, such as the Lely Juno®, may travel. The livestock animals 2 are able to eat the animal feed 5 by pushing their head through the feed fence 6 at a feed fence position 7. In this case, it may happen that a livestock animal slips and falls or is even knocked down by another livestock animal, as can be seen with livestock animal 2-1. If this fall is bad, it may be the case that the livestock animal 2-1 is no longer able to exit from the feed fence on its own. Alternatively, it is also possible for the feed fence 6 to be locked by means of any known locking mechanism for a treatment or examination or the like, but for it to accidentally not be unlocked. In such a case, all animals 2 which are situated at feed fence positions 7 at the feed fence 6 will, in principle, have to remain standing there.

By means of the cameras 8, the interior space of the livestock shed 1, and in particular the livestock space 3, is monitored by capturing images and processing the images in an image-processing device. The latter has not been shown separately and is, in particular, for example, a component of the control unit 12. The cameras 8 at the top left and bottom left in the figure which capture images on two sides of the alley 4-1, the feed fence 6 and the animals 2, 2-1 at the feed fence positions 7 are of particular importance for the present invention.

In most cases, the livestock animals 2 will feed at the feed fence, at one or more feed fence positions 7, for some time in order then to pass along to, for example, a cubicle 9. From the moment when a feed provision action has taken place, such as the pushing back of animal feed 5 by an optional feed pusher 10 or, obviously, the provision of fresh feed at the feed fence 6, the livestock animals 2 will often remain standing at a feed fence position for a slightly longer period of time. Nevertheless, they will eventually leave within a reasonable time frame.

However, if a livestock animal 2 becomes stuck in the feed fence 6, it cannot leave and is forced to remain at the same feed fence position 7. The system according to the invention can detect this in the following way. By means of the images of the cameras 8, the control unit 12, by means of the image-processing device, is able to identify the livestock animals 2 as separate entities, incidentally without necessarily having to identify the identity of the animals. In this case, it is advantageous that, for example, cows are very large animals with well-defined shapes. The contours of the animal are in this case relatively easy to identify. The cameras 8 may in this case be B&W or RGB video cameras or even 3D cameras. In both cases, it is moreover possible to determine the position of each of the detected livestock animals 2, at least at which of the feed fence positions 7 there is a livestock animal 2 present. In addition, the control device 12 is able to monitor how long a livestock animal 2 remains at a certain feed fence position 7. To this end, the control device determines how long the respective livestock animal 2 remains within a threshold distance from the respective feed fence position 7. This threshold distance is obviously smaller than the distance between two neighbouring feed fence positions 7, but may be selected within reasonable limits. In practice, it may be sufficient, for example, to define the “position” of the livestock animal as the position of the head, at least the end comprising the head. This end of, for example, the contour from above may, for example, be pushed through the feed fence 6 when the livestock animal 2 is feeding. At that moment, the occupied feed fence position 7 is clearly defined: as long as the end remains on the same side of the feed fence, the occupied feed fence position 7 does not change. Therefore, if the feed fence position 7 determined in this or any other way does not change for a predetermined time threshold, then the control device 12 deduces that the livestock animal 2 is trapped and will then generate an alarm. For example, an SMS or push message is sent to the cattle breeder or supervisor, if desired provided with the feed fence position and/or optionally an animal identity or other additional information. It is also possible to generate an audible or visible alarm. In addition, the lighting in the livestock space may be switched on, either in the entire space, or locally, at the location of the animal which has generated the alarm. This lighting not only serves as an alarm, but also to provide sufficient light in this situation for the person who is offering help.

The time threshold may be selected based on a variety of factors. Thus, the time threshold may, as has already been indicated above, be longer if fresh feed has just been deposited or pushed back. The time threshold may also advantageously be selected in dependence on the animal, such as in dependence on the ranking or the eating habits of the animal 2. An animal with a low ranking may, for example, be chased away from a feed fence position quickly, and may thus cause an alarm to be raised after a relatively short dwell time.

It is also possible for the time threshold to be selected in dependence on an animal. For example, some animals are fussy and will eat a small amount of feed at many feed fence positions 7. In such a case, the control device may deduce sooner than is normally the case that the respective animal is trapped, if the respective livestock animal remains at a feed fence position for a longer period of time than is the case on average for that animal. It will be clear that the animal locating system (in this case cameras plus image recognition in the control device) then also has to be able to determine individual animal identities. To this end, each livestock animal 2 may, for example, be provided with an optically recognisable identifier, such as a bar code or a colour code. Alternatively, a spotting pattern of the animal may be used, or a recognition at an animal-ID station, such as at a milking station or feeding station, after which the animal is tracked by the cameras 8.

It is also possible to use a different livestock animal locating system instead of cameras 8 and an image-processing device, such as a system in which each livestock animal carries a transmitter, transponder or the like, and in which, in addition, a few receivers are arranged in or around the livestock space for picking up signals from the transmitters, transponders, so that the respective positions of the transmitters, transponders are determined by the accordingly modified control device 12, similar to a local “GPS” system, by means of triangulation or other techniques, which are known per se. The respective transmitter, transponder is then, for example, provided around the neck, in an ear or the like, of the livestock animal 2. Since this is close to the head, the position of the transmitter, transponder determines the relevant position of the livestock animal 2 fairly accurately. Yet other animal-locating devices are not excluded.

It may also happen that a livestock animal becomes trapped because it has slipped, has been pushed over, breaks a leg, etc., and is thus unable to leave the feed fence. By way of example, livestock animal 2-1 has been shown in the figure. Judging by the position of the legs, this animal has slipped and fallen. The contour of this animal is positioned entirely differently to that of the other livestock animals 2, as can clearly be seen by the cameras 8. In such a case, in which the position of the animal is thus at/in a feed fence position 7, but the contour indicates a “non-upright position” of the livestock animal 2-1, it is important to take action much more quickly than after a time threshold has lapsed. Advantageously, the control device 12 is configured to generate a “fall alarm” for such a case, that is to say an alarm comprising a separate indication which signals that the animal has taken a fall, following which an associated corrective action can be taken.

In addition, it is possible for a plurality of, if not all, the animals present at feed fence positions 7 to be stationary, that is to say which position remains longer than a time threshold within a distance threshold at the same feed fence position. In that case, the control device is in particular configured to generate a lock alarm which indicates that the entire feed fence is (or seems to be) locked. It is possible, for such a case, to select a shorter time threshold than for an individual case, because if a plurality of animals are at the feed fence 6 at the same time, it is very unlikely that all of them remain at their feed fence position 7 for a long time without changing position.

If the control device 12 has generated an alarm (individual entrapment alarm, fall alarm, lock alarm or any other alarm), it can furthermore instruct any travelling autonomously navigating vehicle to take the stationary livestock animal 2 into account. For example, a manure slide 11 in the form of a Lely Discovery® or the like travels around the animal shed. In the figure, it travels in the first alley 4-1. However, the control device 12 has detected a trapped animal 2-1 there. It then instructs the manure slide 11 in particular to maintain a predetermined minimum distance to the feed fence position of the animal 2-1, such as for example at least 2 metres, in order to prevent stress or even collisions. It is also possible for the control unit to instruct the vehicle 11 to avoid the first alley 4-1 in its entirety and to travel, for example, along another route, such as to and through the second alley 4-2. Something similar may also apply for autonomously navigating vehicles which are not travelling in the livestock space itself, but for example in the third alley 4-3, where no livestock animals 2 are roaming, but where their heads may nevertheless be located. It may then also be advantageous if the control device 12 instructs the vehicle, such as a feed pusher 10, to maintain a predetermined distance to the respective feed fence position 7 of animal 2-1.

The described embodiment is not intended to be limiting and only serves to explain the invention. The scope of protection is determined by the attached claims.

1. A livestock animal management system, comprising:
a livestock shed with a livestock space for livestock animals,
a feed fence provided in the livestock shed with a plurality of feed fence positions, where the livestock animals are able to eat animal feed through the feed fence,
a livestock animal locating system which is configured for determining and monitoring positions of the livestock animals in the livestock shed, and
a control device which is connected to the livestock animal locating system and is configured for receiving and processing said positions,
wherein the control device is configured for generating an animal alarm if a position of at least one of the livestock animals remains at least within a distance threshold of one of the feed fence positions for at least a predetermined time threshold.

2. The livestock animal management system according to claim 1, wherein the feed fence positions are individually and/or integrally lockable.

3. The livestock animal management system according to claim 1, wherein the time threshold depends on a time since a most recent feed provision event.

4. The livestock animal management system according to claim 3, further comprising an automatic feeding system for dispensing feed at the feed fence, wherein the feeding system is configured to transmit a time of a feed provision event to said control device.

5. The livestock animal management system according to claim 3, wherein the feed provision event comprises providing fresh feed at the feed fence or pushing back previously dispensed feed.

6. The livestock animal management system according to claim 1, wherein the livestock animal locating system comprises a camera system having at least one camera for repeatedly recording images of at least a part of the livestock shed including the feed fence, and an image-processing device for processing the images and identifying one or more animals in said images.

7. The livestock animal management system according to claim 6, wherein the image-processing device is furthermore configured for identifying a deviation from an upright position of a livestock animal in an image.

8. The livestock animal management system according to claim 7, wherein the control device is configured for generating a fall alarm if said deviation is present for at least a fall threshold.

9. The livestock animal management system according to claim 1, wherein the control device is configured for emitting a lock alarm if the positions of a plurality of the livestock animals remain at least within the distance threshold of a respective one of the feed fence positions for at least the predetermined time threshold.

10. The livestock animal management system according to claim 1, furthermore comprising at least one autonomously navigating vehicle in the livestock shed
wherein the control device is configured to instruct said vehicle, when an animal alarm, fall alarm or lock alarm is generated, to maintain at least a predetermined distance to a respective feed fence position.

11. The livestock animal management system according to claim 1, wherein the control device is configured for emitting a lock alarm if the positions of all of the livestock animals remain at least within the distance threshold of a respective one of the feed fence positions for at least the predetermined time threshold.

12. The livestock animal management system according to claim 10, wherein the least one autonomously navigating vehicle is in the livestock space.
